(19) United States
(12) Patent Application Publication
(10) Pub. No.: US 2015/0139505 A1
(43) Pub. Date: May 21, 2015

(54) METHOD AND APPARATUS FOR PREDICTING HUMAN MOTION IN VIRTUAL ENVIRONMENT

(71) Applicant: Electronics and Telecommunications Research Institute, Daejeon (KR)

(72) Inventors: Blagovest Iordanov VLADIMIROV, Changwon (KR); So-Yeon LEE, Daejeon (KR); Sang-Joon PARK, Daejeon (KR); Jong-Hyun PARK, Daejeon (KR); Kyo-Il CHUNG, Daejeon (KR)

(21) Appl. No.: 14/543,506

(22) Filed: Nov. 17, 2014

(30) Foreign Application Priority Data
Nov. 18, 2013 (KR) 10-2013-0140201
Nov. 4, 2014 (KR) 10-2014-0152182

(51) Int. Cl. G06T 7/20; G06T 7/00

(52) U.S. Cl. CPC G06T 7/2046; G06T 7/004; G06T 7/2093; G06T 7/2086; G06T 2207/10028; G06T 2207/30196
USPC 382/107

(57) ABSTRACT

Disclosed are a method and an apparatus for predicting human motion in a virtual environment. The apparatus includes a motion tracking module configured to estimate a human pose of a current time step based on at least one piece of sensor data and a pre-learned motion model, and a motion model module configured to predict a set of probable human poses in the next time step based on the motion model, the estimated human pose of the current time step, and virtual environment context information of the next time step. A sense of immersion of the virtual environment may be maximized.

### CROSS-REFERENCE TO RELATED APPLICATION

This application claims priority to and the benefit of Korean Patent Application No. 2013-0140201, filed on Nov. 18, 2013 and Korean Patent Application No. 2014-0152182, filed on Nov. 4, 2014, the disclosure of which is incorporated herein by reference in its entirety.

### BACKGROUND

1. Technical Field

Exemplary embodiments of the present invention relate to a method and apparatus for predicting human motion in a virtual environment.

2. Discussion of Related Art

Motion tracking devices are utilized as a tool for sensing human motion in a virtual environment for an interaction between the human and the virtual environment.

FIG. 1 is an explanatory diagram illustrating a virtual environment system for the interaction between the human and the virtual environment.

The human 100 moves on a locomotion interface device 25 and moves in a specific direction or takes specific action according to a virtual reality scene projected onto a screen 24. The locomotion interface device 25 is actuated to enable the human to stay within a limited space of the reality world. For example, the locomotion interface device 25 may be actuated in a direction opposite to a human movement direction based on human movement direction information received from a motion tracking device (not illustrated), thereby enabling the human to stay at a given position of the reality world.

The motion tracking device tracks the human motion based on information received from a large number of sensors. The motion tracking device uses a motion model for improving the accuracy of motion tracking and providing information required by the locomotion interface device 25.

In many cases, the recent movement (sequence of poses) of a subject alone does not provide sufficient information to the motion model to predict correctly switching from one action to another. For example, if the subject is walking in a straight line it is difficult to predict a sudden stop, or an abrupt change in the walking direction from the immediately preceding motion (sequence of poses).

### SUMMARY

Exemplary embodiments of the present invention provide measures capable of predicting probable human poses in the next time step in consideration of context information of virtual reality.

According to an exemplary embodiment of the present invention, an apparatus for predicting human motion in a virtual environment includes: a motion tracking module configured to estimate a human pose of a current time step based on at least one piece of sensor data and a pre-learned motion model; and a motion model module configured to predict a set of probable human poses in the next time step based on the motion model, the estimated human pose of the current time step, and virtual environment context information of the next time step.

In the exemplary embodiment, the motion model may include the virtual environment context information of the current time step and information about the human pose of a previous time step and the human pose of the current time step. Here, the virtual environment context information of the current time step may include at least one piece of information about an object present in the virtual environment of the current time step and an event generated in the virtual environment of the current time step.

In the exemplary embodiment, the virtual environment context information of the next time step may include at least one piece of information about an object present in the virtual environment of the next time step and an event generated in the virtual environment of the next time step.

In the exemplary embodiment, the information about the object may include at least one piece of information about a distance between a human and the object, a type of the object, and visibility of the object based on the human.

In the exemplary embodiment, the information about the event may include at least one piece of information about a type of the event and a direction in which the event is generated based on the human.

In the exemplary embodiment, the apparatus may further include: a virtual environment control module configured to control the virtual environment and generate the virtual environment context information of the next time step based on the virtual environment context information of the current time step and the estimated human pose of the current time step to provide the motion model module with the generated virtual environment context information.

In the exemplary embodiment, the human may move on a locomotion interface device, and the apparatus may further include: a locomotion interface control module configured to control the locomotion interface device based on the human pose of the current time step and the human pose of the next time step.

In the exemplary embodiment, the locomotion interface control module may control the locomotion interface device in consideration of a human speed.

According to another exemplary embodiment of the present invention, a method of predicting human motion in a virtual environment includes: estimating a human pose of a current time step based on at least one piece of sensor data and a pre-learned motion model; and predicting a set of probable human poses in the next time step based on the motion model, the estimated human pose of the current time step, and virtual environment context information of the next time step.

In the other exemplary embodiment, the method may further include: constructing the motion model based on the virtual environment context information of the current time step and information about the human pose of a previous time step and the human pose of the current time step.

In the other exemplary embodiment, the method may further include: generating the virtual environment context information of the next time step based on the virtual environment context information of the current time step and the estimated human pose of the current time step.

According to the exemplary embodiments of the present invention, an interaction with a locomotion interface device may be stably achieved.

According to the exemplary embodiments of the present invention, a sense of immersion of the virtual environment may be maximized.

According to the exemplary embodiments of the present invention, the present invention may be utilized as part of a system for tracking human motion in a virtual reality environment in which an interaction with a human is possible for use in training, entertainment, and the like.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is an explanatory diagram illustrating a virtual environment system for an interaction between a human and a virtual environment;

FIG. 2 is a block diagram illustrating a human motion prediction apparatus according to an exemplary embodiment of the present invention;

FIG. 3 is an explanatory diagram illustrating a motion model network according to conventional technology;

FIG. 4A and FIG. 4B are explanatory diagrams illustrating a motion model network according to an exemplary embodiment of the present invention;

FIG. 5A, FIG. 5B, FIG. 6A, FIG. 6B, FIG. 7A and FIG. 7B are explanatory diagrams illustrating a process of predicting a set of probable human poses in the next time step in consideration of context information of a virtual environment according to exemplary embodiments of the present invention; and

FIG. 8 is a flowchart illustrating a human motion prediction method according to an exemplary embodiment of the present invention.

### DETAILED DESCRIPTION

Hereinafter, embodiments of the present invention will be described. In the following description of the present invention, detailed description of known configurations and functions incorporated herein has been omitted when they may make the subject matter of the present invention unclear. Hereinafter the embodiments of the present invention will be described with reference to the accompany drawings.

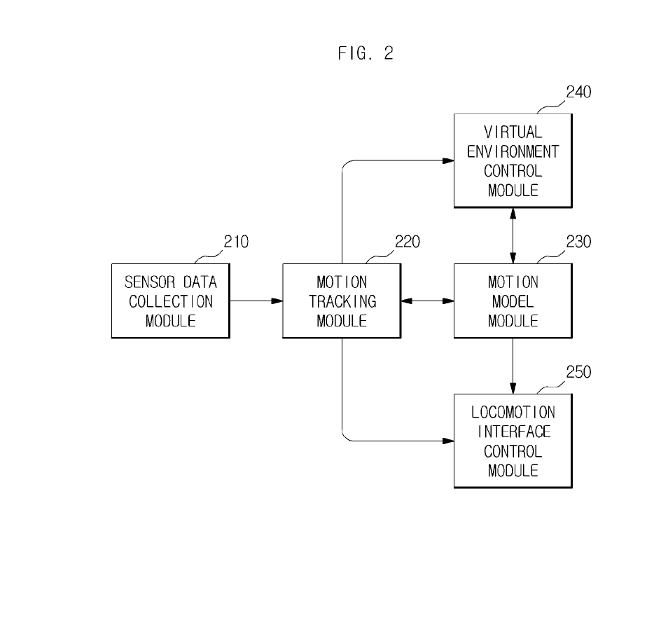

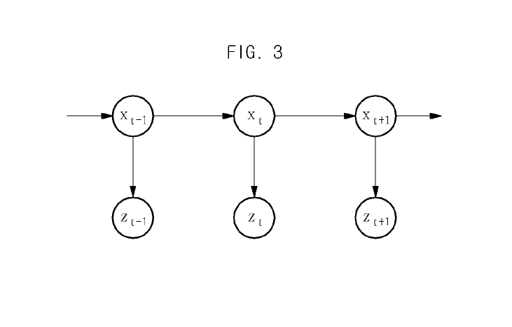

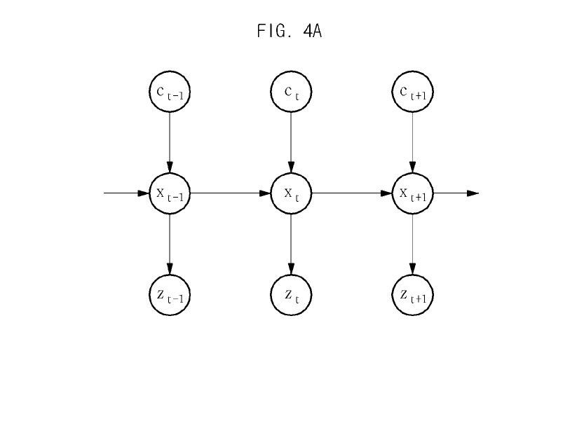

FIG. 2 is a block diagram illustrating a human motion prediction apparatus according to an exemplary embodiment of the present invention.

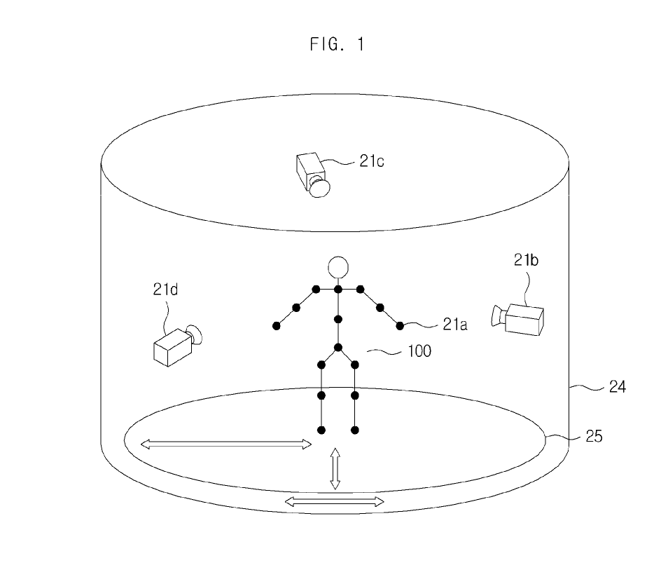

A sensor data collection module 210 collects sensor data necessary for motion tracking. The exemplary embodiments of the present invention may be applied to a virtual environment system illustrated in FIG. 1. Accordingly, the sensor data collection module 210 may collect sensor data necessary for motion tracking from one or more depth cameras 21b, 21c, and 21d and at least one motion sensor 21a attached to the body of a human 100.

The sensor data collection module 210 may perform time synchronization and pre-processing on the collected sensor data and transfer results of the time synchronization and pre-processing to a motion tracking module 220.

The motion tracking module 220 estimates a human pose of a current time step based on the sensor data received from the sensor data collection module 210 and information about a set of probable poses obtained from the motion model.

The motion model may be a skeleton model as a pre-learned model for the human. Also, the estimated human pose of the current time step may be represented by a set of joint angles of the skeleton model.

The motion model may be generated using various methods. For example, the motion model may be generated using a method of attaching a marker to the human body and tracking the attached marker or generated using a marker-free technique using a depth camera without a marker.

The human pose of the current time step may be estimated using various methods. For example, a commonly used approach is as follows. Starting from an initial guess about the human pose (a trainee's pose), a three dimensional (3D) silhouette is reconstructed from the pose and is matched against the observations (e.g., 3D point cloud obtained from the depth images). An error measure reflecting the mismatch then is minimized by varying the pose parameters (e.g. joint angles). The pose that results in a minimal error is selected as the current pose.

In this process, a good initial guess results in faster convergence and/or smaller error in the estimated pose. Because we use the poses predicted by the motion model for the initial guess, it is important to have a good motion model.

A motion model module 230 stores the motion model and predicts probable poses after the human pose of the current time step estimated in the motion tracking module 220, that is, a set of probable poses by the human.

The prediction may be performed based on at least one of the pre-learned model (that is, a motion model), the estimated human pose of the current time step, additional features extracted from the sensor data, and virtual environment context information.

For example, the additional features extracted from sensor data may include at least one of (i) linear velocity and acceleration computed from joint positions, (ii) angular velocity and acceleration computed from joint angles, (iii) symmetry measures computed on a subset of the joints and (iv) volume spanned by a subset of the joints, etc.

The virtual environment situation information includes information about an object present in a virtual environment previewed to the human and an event. This will be described later with reference to the related drawings.

On the other hand, in Reference Literature (D. J. Fleet, “Motion Models for People Tracking,” in Visual Analysis of Humans: Looking at People, T. B. Moeslund, A. Hilton, V. Kruger and L. Sigal, Eds., Springer, 2011, pp. 171 to 198.), human pose tracking is mathematized as a Bayesian filtering problem as shown in Equation (1).)

p(xₜ|z_{1:t})∝p(zₜ|xₜ)∫p(xₜ|xₜ₋₁)p(xₜ₋₁|z_{1:t-1})dxₜ₋₁ (1)

Here, xₜ represents a pose at time step t, zₜ is an observation value (for example, a depth image or a point cloud) at time step t, z_{1:t-t} represents a set of observation values from time step 1 to time step t−1. The modeled dependencies among the variables are shown in FIG. 3 which illustrates a motion model network according to conventional technology.

p(xₜ|xₜ₋₁) is a general representation for a motion model modeled as a first-order Markov process, and captures the dependency of a pose xₜ of current time step t upon a pose xₜ₋₁ observed at previous time step t−1.

However, sometimes it is insufficient to estimate the pose of current time step t from only the pose xₜ₋₁ observed at previous time step t−1.

Using additional information from the context information of the virtual environment allows us to build a motion model that outperforms a motion model using only information from the human motion.

In the exemplary embodiments of the present invention, the motion model having improved performance is constructed in consideration of the context information of the virtual environment. The motion model may be constructed by the motion model module 230 through training. The motion model module 230 may construct a motion model based on the human pose of the previous time step, the human pose of the current time step, and the virtual environment context information of the current time step. For example, the motion model module 230 may configure the virtual environment context information of the current time step as a variable (which may be represented as a vector), and generate a motion model including the variable, the human pose of the previous time step, and the human pose of the current time strep.

When the virtual environment context information is used, the motion model may be represented by p(xₜ|xₜ₋₁, cₜ) as shown in Equation (2).

p(xₜ|z_{1:t},c₁)∝p(zₜ|xₜ)∫p(xₜ|xₜ₋₁,cₜ)p(xₜ₋₁|z_{1:(t-1}),cₜ₋₁)dxₜ₋₁ (2)

Here, cₜ represents the virtual environment context information at time step t.

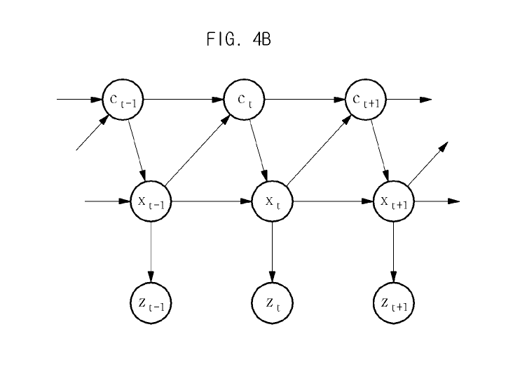

Initially, we can use virtual environment context information c under the simplifying assumption that the values from different time steps are independent of each other. In this case, the dependencies among the variables c (context), x (pose) and z (observation value) at consecutive time steps are illustrated in FIG. 4A which illustrates a motion model network according to an exemplary embodiment of the present invention. The corresponding equation is Equation (2).

Dependencies among variables introduced by interactions between a trainee's actions and a virtual environment context (for example, if a training scenario changes based on the trainee's actions, this introduces dependency from a latent variable xₜ at time step t to virtual environment context information cₜ₊₁; or dependencies between the virtual environment context at consecutive time steps, for example, the context cₜ at time step t, may depend on the context cₜ₋₁ at the previous time step t−1) may also be modelled. The corresponding dependencies among the variables are shown in FIG. 4B which illustrates a motion model network according to an exemplary embodiment of the present invention.

A vector cₜ representing the virtual environment context information may include various information about an object present in the virtual environment and an event. The information, for example, may be information about the presence/absence of an object, a distance from the object, the presence/absence of occurrence of a specific event, a type of the specific event, a position of occurrence of the specific event.

Table 1 shows an example of data to be transmitted between modules of a motion tracking device according to an exemplary embodiment of the present invention.

TABLE 1

| Source | | |
|---|---|---|
| module | Arrival module | Data |
| Motion | Motion model | Human pose estimated in current time |
| tracking | module | step |
| module | | (represented by skeleton technique and |
| | | including joint angle, velocity, and the |
| | | like) |
| Virtual | Motion model | [1] Information about obstacle |
| environment | module | Distance to obstacle in human |
| control | | movement direction |
| module | | Type of obstacle |
| | | [2] Information about agent |
| | | Distance between human and virtual |
| | | agent |
| | | Type of agent (friend, foe) |
| | | Whether agent is visible in field of |
| | | view of human |
| Motion | Motion tracking | Human pose predicted in next time step |
| model | module | (represented by skeleton technique) |
| module | Virtual | |
| | environment | |
| | control module | |
| | Locomotion | |
| | interface | |
| | control module | |

As shown in Table 1, the motion model module 230 may predict a set of probable human poses in the next time step in consideration of virtual environment context information received from a virtual environment control module 240. In other words, the motion model module 230 may predict a set of probable poses in the next time step by applying the virtual environment context information of the current time step as a parameter of the motion model.

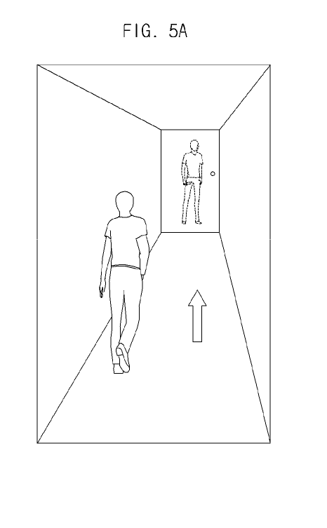

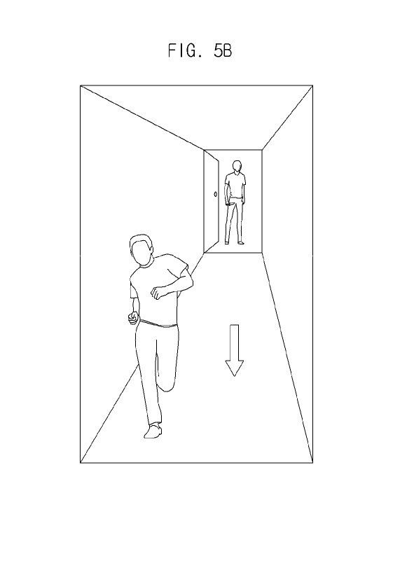

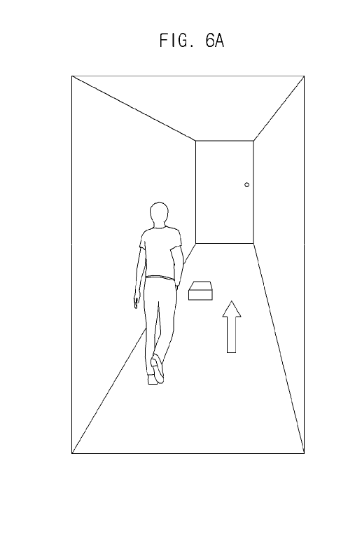

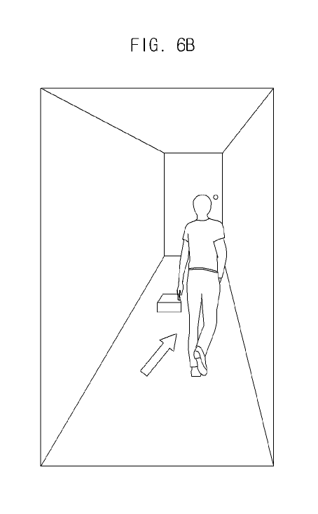

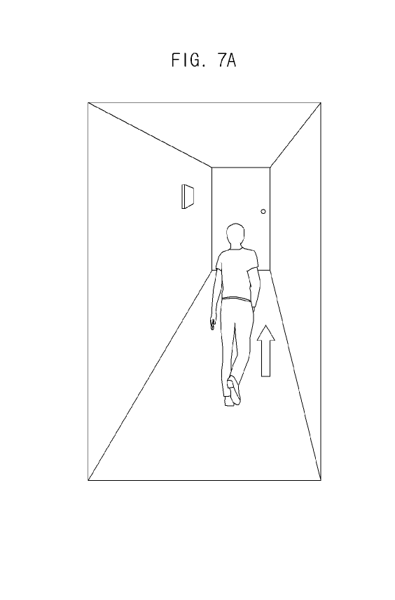

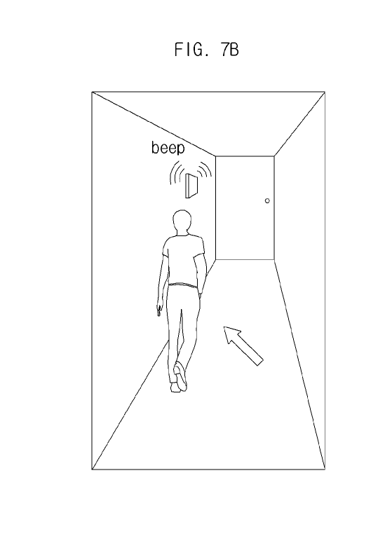

FIG. 5A, FIG. 5B, FIG. 6A, FIG. 6B, FIG. 7A and FIG. 7B are explanatory diagrams illustrating a process of predicting a set of probable human poses in the next time step in consideration of context information of a virtual environment according to exemplary embodiments of the present invention.

For example, the visibility of the object by the human may be used to predict the set of probable human poses in the next time step. For example, the presence of the object to be suddenly viewed in a state in which the object is not viewed in the field of view of the human may increase a probability of human movement in a specific direction. For example, as illustrated in FIG. 5A, an adversary hidden behind a closed door is not visible in the current time step. The adversary is visible to the human in the next time step if the virtual environment context information of the next time step represents a state in which the door is open as illustrated in FIG. 5B. Accordingly, the human is likely to move in a direction opposite to a direction in which the adversary is present or move to avoid an attack of the adversary. Accordingly, the motion model module 230 may predict a set of probable human poses in the next time step by applying this virtual environment context information as a parameter of the motion model.

For example, the presence of the obstacle or the distance from the obstacle may be used to predict the set of probable human poses in the next time step. For example, as illustrated in FIG. 6A, it is assumed that the obstacle is placed in a direction in which the human moves in the current time step and a distance between the human and the obstacle is sufficiently long in the current time step. If the virtual environment context information of the next time step represents that the distance between the human and the obstacle is very short in the current time step as illustrated in FIG. 6B, the presence of the obstacle affects a human movement direction. That is, the human is likely to change the movement direction so as to avoid a collision with the relevant obstacle. Accordingly, the motion model module 230 may predict a set of probable human poses in the next time step by applying this virtual environment context information as a parameter of the motion model.

For example, the occurrence of a specific event may be used to predict a set of probable human poses in the next time step. For example, as illustrated in FIG. 7A, a state in which no event occurs around the human in the current time step is assumed. If the virtual environment context information of the next time step represents that a beep sound is generated from a specific object positioned in the front as illustrated in FIG. 7B, the beep sound may affect the human movement direction. That is, the human is likely to change the movement direction toward the object from which the beep sound is generated. Accordingly, the motion model module 230 may predict a set of probable human poses in the next time step by applying this virtual environment context information as a parameter of the motion model.

The virtual environment control module 240 controls a virtual environment projected onto the screen 24. For example, the virtual environment control module 240 controls an event of appearance, disappearance, motion, or the like of an object such as a thing or a person and a state of the object (for example, an open state or a closed state of a door).

A locomotion interface control module 250 controls the actuation of the locomotion interface device 25. The locomotion interface control module 250 may control the locomotion interface device based on an estimated human pose, movement direction and speed of the current time step and a set of probable poses of the next time step. Information about the human movement direction and speed may be received from a separate measurement device.

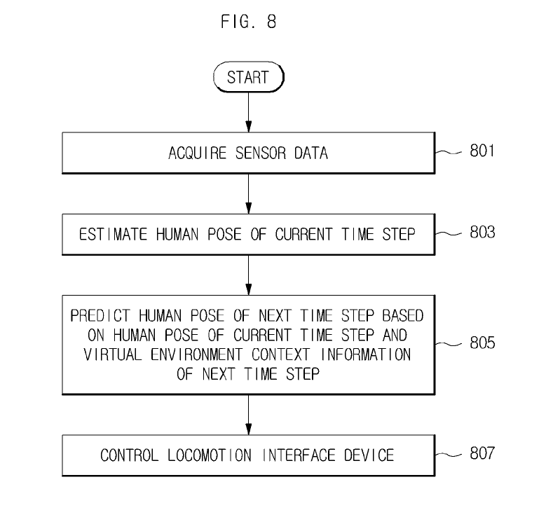

FIG. 8 is a flowchart illustrating a human motion prediction method according to an exemplary embodiment of the present invention.

In operation 801, the human motion prediction apparatus acquires sensor data. The sensor data are data necessary for motion tracking. For example, the sensor data may be received from at least one depth camera photographing the human and at least one motion sensor attached to a human body.

In operation 803, the human motion prediction apparatus estimates a human pose of a current next time step. The human pose of the current time step may be estimated based on a pre-learned motion model and the collected sensor data.

In operation 805, the human motion prediction apparatus predicts a human pose of the next time step. The human motion prediction apparatus may use at least one of the motion model, the human pose of the current time step, features extracted from the sensor data, and virtual environment context information so as to predict the human pose of the next time step.

In operation 807, the human motion prediction apparatus controls the locomotion interface device based on a set of predicted poses of the next time step. For example, when the set of predicted poses of the next time step represents movement in the front direction, the human motion prediction apparatus actuates the locomotion interface device in the rear direction.

The above-described exemplary embodiments of the present invention may be embodied in various methods. For example, exemplary embodiments of the present invention may be embodied as hardware, software or a combination of hardware and software. When the exemplary embodiments of the present invention are embodied as software, software that is implemented in one or more processors using various operation systems or platforms may be embodied. In addition, the software may be written using one of a plurality of appropriate programming languages, or may be compiled to a machine code or an intermediate code implemented in a frame work or a virtual machine.

When the exemplary embodiments of the present invention are embodied in one or more processors, the exemplary embodiments of the present invention may be embodied as a processor-readable medium that records one or more programs for executing the method embodying the various embodiments of the present invention, for example, a memory, a floppy disk, a hard disk, a compact disc, an optical disc, a magnetic tape, and the like.

What is claimed is:

1. An apparatus for predicting human motion in a virtual environment, the apparatus comprising:
a motion tracking module configured to estimate a human pose of a current time step based on at least one piece of sensor data and a pre-learned motion model; and
a motion model module configured to predict a set of probable human poses in the next time step based on the motion model, the estimated human pose of the current time step, and virtual environment context information of the next time step.

2. The apparatus of claim 1, wherein the motion model includes the virtual environment context information of the current time step and information about the human pose of a previous time step and the human pose of the current time step.

3. The apparatus of claim 2, wherein the virtual environment context information of the current time step includes at least one piece of information about an object present in the virtual environment of the current time step and an event generated in the virtual environment of the current time step.

4. The apparatus of claim 1, wherein the virtual environment context information of the next time step includes at least one piece of information about an object present in the virtual environment of the next time step and an event generated in the virtual environment of the next time step.

5. The apparatus of claim 4, wherein the information about the object includes at least one piece of information about a distance between a human and the object, a type of the object, and visibility of the object based on the human.

6. The apparatus of claim 4, wherein the information about the event includes at least one piece of information about a type of the event and a direction in which the event is generated based on the human.

7. The apparatus of claim 1, further comprising:
a virtual environment control module configured to control the virtual environment and generate the virtual environment context information of the next time step based on the virtual environment context information of the current time step and the estimated human pose of the current time step to provide the motion model module with the generated virtual environment context information.

8. The apparatus of claim 1,
wherein the human moves on a locomotion interface device, and
wherein the apparatus further comprises:
a locomotion interface control module configured to control the locomotion interface device based on the human pose of the current time step and the human pose of the next time step.

9. The apparatus of claim 8, wherein the locomotion interface control module controls the locomotion interface device in consideration of a human speed.

10. A method of predicting human motion in a virtual environment, the method comprising:
estimating a human pose of a current time step based on at least one piece of sensor data and a pre-learned motion model; and
predicting a set of probable human poses in the next time step based on the motion model, the estimated human pose of the current time step, and virtual environment context information of the next time step.

11. The method of claim 10, further comprising:
constructing the motion model based on the virtual environment context information of the current time step and information about the human pose of a previous time step and the human pose of the current time step.

12. The method of claim 11, wherein the virtual environment context information of the current time step includes at least one piece of information about an object present in the virtual environment of the current time step and an event generated in the virtual environment of the current time step.

13. The method of claim 10, wherein the virtual environment context information of the next time step includes at least one piece of information about an object present in the virtual environment of the next time step and an event generated in the virtual environment of the next time step.

14. The method of claim 13, wherein the information about the object includes at least one piece of information about a distance between a human and the object, a type of the object, and visibility of the object based on the human.

15. The method of claim 13, wherein the information about the event includes at least one piece of information about a type of the event and a direction in which the event is generated based on the human.

16. The method of claim 10, further comprising:
generating the virtual environment context information of the next time step based on the virtual environment context information of the current time step and the estimated human pose of the current time step.

17. The method of claim 10,
wherein the human moves on a locomotion interface device, and
wherein the method further comprises controlling the locomotion interface device based on the human pose of the current time step and the set of probable human poses in the next time step.

18. The method of claim 17, wherein the controlling of the locomotion interface device includes:
controlling the locomotion interface device in consideration of a human speed.
